(19) United States
(12) Patent Application Publication
(10) Pub. No.: US 2026/0241216 A1
(43) Pub. Date: Aug. 20, 2026

(54) SPRINKLER HEAD HAVING ONE-PIECE CLOSURE BODY

(71) Applicant: Job Lizenz GmbH, Ahrensburg (DE)

(72) Inventors: Bodo MÜLLER, Tornesch (DE); Jürgen TESCHNER, Hamburg (DE); Rüdiger KLUG, Ahrensburg (DE); Volker Andreas HANSEN, Kreuzfeld/Malente (DE); Hanno KAMP, Lübeck (DE)

(73) Assignee: Job Lizenz GmbH, Ahrensburg (DE)

(21) Appl. No.: 19/160,571

(22) PCT Filed: Feb. 8, 2024
(86) PCT No.: PCT/EP2024/053217

§ 371 Date: Aug. 28, 2025

(30) Foreign Application Priority Data
Mar. 1, 2023 (DE) 20 2023 100 969.7

(51) Int. Cl. A62C 31/02; A62C 37/14

(52) U.S. Cl. CPC A62C 31/02; A62C 37/14

(57) ABSTRACT

A sprinkler head for a sprinkler system having a pipe section for a sprinkler fluid. The pipe section is designed to connect to a connector of a sprinkler pipe of a sprinkler system at a first end and has an outlet opening at a second end, and as a closure element for sealing the outlet opening of the pipe section. The sprinkler head has an abutment element connected to the pipe section and a release element arranged between the abutment element and the closure element. The release element is designed in a normal state, to hold the closure element in the outlet opening of the pipe section in such a way that the closure element seals the outlet opening of the pipe section and in a release state, to release the closure element form the position in which it closes the outlet opening of the pipe section.

### TECHNICAL FIELD

The invention relates to a sprinkler head with a closure element for the sealed closure of an outlet opening of a pipe section of the sprinkler head as well as to such a closure element itself. It further relates to the use of such a closure element in a sprinkler head and also to a sprinkler system having a sprinkler head as described.

### BACKGROUND ART

Sprinkler systems have been used for fire protection and firefighting in buildings for many decades. Such sprinkler systems typically comprise a storage tank containing sprinkler fluid under a certain pressure and a pipe or pipe system connected to the storage tank, which has distribution lines or distribution pipes that end in ceiling areas of rooms to be protected and into which sprinkler heads are inserted. Such sprinkler heads have valves that are normally closed but open in case of release and allow the sprinkler fluid to drain out. These valves are often formed by a closure element that seals an outlet opening, which is held in the closed position by means of a release element and is released from this position when the release element is released. Typically, sprinkler heads also have baffle and distribution plates that deflect and distribute pressurized sprinkler fluid to cover a large area.

As already mentioned, the valves of the sprinkler heads are typically kept closed by release elements, preferably thermal release elements, which are arranged between an abutment section designed to support them and a closure element of the valve and thus normally keep the valve and thus an outlet of the sprinkler fluid closed. In the event of heating due to fire, the thermal release elements heat up to a release temperature, causing them to release and disengaging the locking elements, opening the respective valve and thus opening the outlet for the sprinkler fluid. Typical thermal release elements can in particular comprise support bodies made of a fusible link or glass ampules, also called glass vessels, which are filled with a release fluid, usually also with a gas bubble. The latter are released by the fact that when heated, the thermal release fluid expands and builds up pressure inside the glass vessel, which ultimately causes the wall of the glass vessel to burst, destroying the glass ampule.

It is particularly important for the functionality of such sprinkler heads that the release element is fixed between the abutment element and the closure element in such a way that the former is held immobile, insofar as it is firmly clamped between the abutment and the closure element. Due to the resulting force exerted by the closure element as well as the abutment element or the applied clamping force, there is a fundamental risk that a glass ampule could burst unintentionally and thus the sprinkler head could be released unintentionally. To prevent this, a spring is usually provided as an additional component on the closure element to control the force effect. In particular, such a spring-usually a disc spring-enables the glass ampule to be inserted between the abutment element and the closure element. The spring also allows the compensation of dimensional variations of the abutment, closure element and/or release element that occur, for example, due to temperature fluctuations.

At the same time, the use of such a spring designed as a separate element means that there may be a potential weak point for the sealing of the outlet opening of the sprinkler head, either at this point or through the interaction of this spring with the closure element. In particular, such a risk always exists when an exact positioning of the parts cannot be achieved when inserting the valve assembly consisting of the spring, closing element and release element. Such springs are also made of a metal, e.g., spring steel, and their material is usually subject to the risk of corrosion or the like, or their spring effect can deteriorate over the period of use of the spring, or in particular can even be lost completely. Furthermore, in particular, the movements of the valve element in the sprinkler head caused by temperature fluctuations in the environment, for example due to different ambient temperatures in summer and winter, and the varying expansion of the materials of the components involved can lead to wear at the joints between the spring and the closure element, which impairs the seal of the closure. In particular, since the spring and the closure body are usually made of different materials, they are usually subject to different degrees of expansion, which can further intensify the above-mentioned wear. Since sprinkler heads typically remain installed in sprinkler systems for several years, often even decades, even minor wear over time can lead to a potential sealing problem.

### SUMMARY OF THE INVENTION

Based on the above-described deficiencies of known sprinkler heads, there is a need to adapt them in such a way that, in particular, correct positioning of the components of the sprinkler head is facilitated during its assembly and that a reliable and permanent seal of the valve in the sprinkler head is achieved.

This objective is achieved according to the invention by a sprinkler head having the features of a sprinkler head (1) for a sprinkler system, comprising. a pipe section (6) for a sprinkler fluid, wherein the pipe section (6) is designed at a first end (8, 9) for connecting to a connection of a sprinkler pipe of a sprinkler system and has an outlet opening (7) at a second end; ·a closure element (10) designed for sealed closure of the outlet opening (7) of the pipe section (6); ·an abutment element (4) connected to the pipe section (6); ·a release element (12) arranged between the abutment element (4) and the closure element (10), wherein the release element (12) is formed, o in a normal state, to hold the closure element (10) in the outlet opening (7) of the pipe section (6) in such a way that the closure element (10) seals the outlet opening (7) of the pipe section (6), and o in a release state, to release the closure element (10) from its position closing the outlet opening (7) of the pipe section (6), characterized in that the closure element (10) is a closure body (10) consisting of an elastic, in particular spring-elastic, material and the closure body (10) is formed in one piece, a closure body consisting of an elastic, in particular spring-elastic, material and formed in one piece with the features of a closure body (10) for a sprinkler head (1), in particular for a sprinkler head (1) according to one of the preceding claims, consisting of an elastic, in particular spring-elastic, material and formed in one piece, a use of such a closure body for a sprinkler head (1), in particular for a sprinkler head (1), consisting of an elastic, in particular spring-elastic, material and formed in one piece; characterized in that it is plate-shaped with an outer, substantially flat edge portion (16) and a central protrusion (13) for receiving a portion (14) of a release element (12); or characterized in that the edge section (16) is inclined to a main extension plane of the closure body (10) according to the invention in a sprinkler head in particular a sprinkler head (1) for a sprinkler system, comprising. a pipe section (6) for a sprinkler fluid, wherein the pipe section (6) is designed at a first end (8, 9) for connecting to a connection of a sprinkler pipe of a sprinkler system and has an outlet opening (7) at a second end; ·a closure element (10) designed for sealed closure of the outlet opening (7) of the pipe section (6); ·an abutment element (4) connected to the pipe section (6); ·a release element (12) arranged between the abutment element (4) and the closure element (10), wherein the release element (12) is formed, o in a normal state, to hold the closure element (10) in the outlet opening (7) of the pipe section (6) in such a way that the closure element (10) seals the outlet opening (7) of the pipe section (6), and o in a release state, to release the closure element (10) from its position closing the outlet opening (7) of the pipe section (6), characterized in that the closure element (10) is a closure body (10) consisting of an elastic, in particular spring-elastic, material and the closure body (10) is formed in one piece; characterized in that the closure body (10) is designed, in the normal state of the release element (12), to withstand a fluid pressure exerted on the closure body (10) by the sprinkler fluid in the pipe section (6) while maintaining the sealed closure of the outlet opening (7) and, in the release state, to be moved out of the outlet opening (7) by the fluid pressure in such a way that the outlet opening (7) is released for the sprinkler fluid to flow; characterized in that the closure body (10) in the normal state withstands a fluid pressure of at least 30 bar; characterized by a nominal K-factor of at least 20 [L/min/(bar)^{1/2}], in particular at least 57 [L/min/(bar)^{1/2}], in particular at least 80 [L/min/(bar)^{1/2}], in particular at least 115 [L/min/(bar)^{1/2}], in particular at least 160 [L/min/(bar)^{1/2}], in particular at least 360 [L/min/(bar)^{1/2}], and/or up to 400 [L/min/(bar)^{1/2}]; characterized in that the closure body (10) and/or the release element (12) is and/or are held in the normal state by a pre-stressing force of between 200 N and 1000 N, in particular between 200 N and 800 N; characterized in that the closure body (10) seals the outlet opening (7) in the normal state of the release element (12) without interaction with a further element existing next to the release element (12); characterized in that the closure body (10) consists of a plastic, in particular a polymer, preferably a polyamide, in particular a partially aromatic polyamide; or characterized by a glass ampule (12) as the release element (12), wherein the glass ampule (12) is filled in particular with a gas and/or a fluid, in particular with a boiling point not exceeding a release temperature, and is in particular designed to be able to burst by heating, in particular by expansion of the gas and/or the fluid and/or by evaporation of the fluid in the glass ampule (12) and a sprinkler system with a sprinkler head wherein the sprinkler head comprising ·a pipe section (6) for a sprinkler fluid, wherein the pipe section (6) is designed at a first end (8, 9) for connecting to a connection of a sprinkler pipe of a sprinkler system and has an outlet opening (7) at a second end; ·a closure element (10) designed for sealed closure of the outlet opening (7) of the pipe section (6); ·an abutment element (4) connected to the pipe section (6); ·a release element (12) arranged between the abutment element (4) and the closure element (10), wherein the release element (12) is formed, o in a normal state, to hold the closure element (10) in the outlet opening (7) of the pipe section (6) in such a way that the closure element (10) seals the outlet opening (7) of the pipe section (6), and o in a release state, to release the closure element (10) from its position closing the outlet opening (7) of the pipe section (6), characterized in that the closure element (10) is a closure body (10) consisting of an elastic, in particular spring-elastic, material and the closure body (10) is formed in one piece; characterized in that the closure body (10) is designed, in the normal state of the release element (12), to withstand a fluid pressure exerted on the closure body (10) by the sprinkler fluid in the pipe section (6) while maintaining the sealed closure of the outlet opening (7) and, in the release state, to be moved out of the outlet opening (7) by the fluid pressure in such a way that the outlet opening (7) is released for the sprinkler fluid to flow; characterized in that the closure body (10) in the normal state withstands a fluid pressure of at least 30 bar; characterized by a nominal K-factor of at least 20 [L/min/(bar)^{1/2}], in particular at least 57 [L/min/(bar)^{1/2}], in particular at least 80 [L/min/(bar)^{1/2}], in particular at least 115 [L/min/(bar)^{1/2}], in particular at least 160 [L/min/(bar)^{1/2}], in particular at least 360 [L/min/(bar)^{1/2}], and/or up to 400 [L/min/(bar)^{1/2}]; characterized in that the closure body (10) and/or the release element (12) is and/or are held in the normal state by a pre-stressing force of between 200 N and 1000 N, in particular between 200 N and 800 N; characterized in that the closure body (10) seals the outlet opening (7) in the normal state of the release element (12) without interaction with a further element existing next to the release element (12); characterized in that the closure body (10) consists of a plastic, in particular a polymer, preferably a polyamide, in particular a partially aromatic polyamide; or characterized by a glass ampule (12) as the release element (12), wherein the glass ampule (12) is filled in particular with a gas and/or a fluid, in particular with a boiling point not exceeding a release temperature, and is in particular designed to be able to burst by heating, in particular by expansion of the gas and/or the fluid and/or by evaporation of the fluid in the glass ampule (12) in particular with a closure body (10) for a sprinkler head (1), in particular for a sprinkler head (1) comprising ·a pipe section (6) for a sprinkler fluid, wherein the pipe section (6) is designed at a first end (8, 9) for connecting to a connection of a sprinkler pipe of a sprinkler system and has an outlet opening (7) at a second end; ·a closure element (10) designed for sealed closure of the outlet opening (7) of the pipe section (6); ·an abutment element (4) connected to the pipe section (6); ·a release element (12) arranged between the abutment element (4) and the closure element (10), wherein the release element (12) is formed, o in a normal state, to hold the closure element (10) in the outlet opening (7) of the pipe section (6) in such a way that the closure element (10) seals the outlet opening (7) of the pipe section (6), and o in a release state, to release the closure element (10) from its position closing the outlet opening (7) of the pipe section (6), characterized in that the closure element (10) is a closure body (10) consisting of an elastic, in particular spring-elastic, material and the closure body (10) is formed in one piece; characterized in that the closure body (10) is designed, in the normal state of the release element (12), to withstand a fluid pressure exerted on the closure body (10) by the sprinkler fluid in the pipe section (6) while maintaining the sealed closure of the outlet opening (7) and, in the release state, to be moved out of the outlet opening (7) by the fluid pressure in such a way that the outlet opening (7) is released for the sprinkler fluid to flow; characterized in that the closure body (10) in the normal state withstands a fluid pressure of at least 30 bar; characterized by a nominal K-factor of at least 20 [L/min/(bar)^{1/2}], in particular at least 57 [L/min/(bar)^{1/2}], in particular at least 80 [L/min/(bar)^{1/2}], in particular at least 115 [L/min/(bar)^{1/2}], in particular at least 160 [L/min/(bar)^{1/2}], in particular at least 360 [L/min/(bar)^{1/2}], and/or up to 400 [L/min/(bar)^{1/2}]; characterized in that the closure body (10) and/or the release element (12) is and/or are held in the normal state by a pre-stressing force of between 200 N and 1000 N, in particular between 200 N and 800 N; characterized in that the closure body (10) seals the outlet opening (7) in the normal state of the release element (12) without interaction with a further element existing next to the release element (12); characterized in that the closure body (10) consists of a plastic, in particular a polymer, preferably a polyamide, in particular a partially aromatic polyamide; or characterized by a glass ampule (12) as the release element (12), wherein the glass ampule (12) is filled in particular with a gas and/or a fluid, in particular with a boiling point not exceeding a release temperature, and is in particular designed to be able to burst by heating, in particular by expansion of the gas and/or the fluid and/or by evaporation of the fluid in the glass ampule (12); the closure body characterized in that it is plate-shaped with an outer, substantially flat edge portion (16) and a central protrusion (13) for receiving a portion (14) of a release element (12); the closure body characterized in that the edge section (16) is inclined to a main extension plane of the closure body (10); the closure body characterized in that it consists of a, in particular fiber-reinforced, plastic, in particular a polymer, preferably a, in particular partially aromatic, polyamide; the closure body characterized in that the closure body (10) has a tensile modulus between 20,000 and 40,000 MPa, in particular between 25,000 and 40,000 MPa, in particular between 25,000 and 30,000 MPa and/or a breaking stress between 200 and 400 MPa, in particular between 250 and 400 MPa, in particular between 250 and 300 MPa and/or a breaking expansion between 0.5 and 2.5%, in particular between 1 and 2% and/or Charpy impact strength between 20 and 100KJ/m 2, especially between 40 and 80KJ/m 2, especially between 50 and 70 KJ/m 2 and/or Charpy notched impact strength between 5 and 30 kJ/m 2, especially between 10 and 20KJ/m 2, in particular one with such a closure element according to the invention. Advantageous further developments of a sprinkler head characterized in that the closure body (10) is designed, in the normal state of the release element (12), to withstand a fluid pressure exerted on the closure body (10) by the sprinkler fluid in the pipe section (6) while maintaining the sealed closure of the outlet opening (7) and, in the release state, to be moved out of the outlet opening (7) by the fluid pressure in such a way that the outlet opening (7) is released for the sprinkler fluid to flow; characterized in that the closure body (10) in the normal state withstands a fluid pressure of at least 30 bar; characterized by a nominal K-factor of at least 20 [L/min/(bar)^{1/2}], in particular at least 57 [L/min/(bar)^{1/2}], in particular at least 80 [L/min/(bar)^{1/2}], in particular at least 115 [L/min/(bar)^{1/2}], in particular at least 160 [L/min/(bar)^{1/2}], in particular at least 360 [L/min/(bar)^{1/2}], and/or up to 400 [L/min/(bar)^{1/2}]; characterized in that the closure body (10) and/or the release element (12) is and/or are held in the normal state by a pre-stressing force of between 200 N and 1000 N, in particular between 200 N and 800 N; characterized in that the closure body (10) seals the outlet opening (7) in the normal state of the release element (12) without interaction with a further element existing next to the release element (12); characterized in that the closure body (10) consists of a plastic, in particular a polymer, preferably a polyamide, in particular a partially aromatic polyamide; or characterized by a glass ampule (12) as the release element (12), wherein the glass ampule (12) is filled in particular with a gas and/or a fluid, in particular with a boiling point not exceeding a release temperature, and is in particular designed to be able to burst by heating, in particular by expansion of the gas and/or the fluid and/or by evaporation of the fluid in the glass ampule (12), and those of a closure body characterized in that it is plate-shaped with an outer, substantially flat edge portion (16) and a central protrusion (13) for receiving a portion (14) of a release element (12); characterized in that the edge section (16) is inclined to a main extension plane of the closure body (10); characterized in that it consists of a, in particular fiber-reinforced, plastic, in particular a polymer, preferably a, in particular partially aromatic, polyamide; or characterized in that the closure body (10) has a tensile modulus between 20,000 and 40,000 MPa, in particular between 25,000 and 40,000 MPa, in particular between 25,000 and 30,000 MPa and/or a breaking stress between 200 and 400 MPa, in particular between 250 and 400 MPa, in particular between 250 and 300 MPa and/or a breaking expansion between 0.5 and 2.5%, in particular between 1 and 2% and/or Charpy impact strength between 20 and 100KJ/m², especially between 40 and 80KJ/m², especially between 50 and 70 KJ/m² and/or Charpy notched impact strength between 5 and 30KJ/m², especially between 10 and 20KJ/m².

According to the invention, a sprinkler head for a sprinkler system initially has a pipe section for a sprinkler fluid, wherein this pipe section is designed at a first end for connecting to a connection of a sprinkler pipe of a sprinkler system, e.g., via a screw thread. The pipe section also has an outlet opening at a second end. Furthermore, according to the invention, the sprinkler head has a closure element for the sealed closure of the outlet opening of the pipe section. It also has an abutment section connected to the pipe section and a release element arranged between the abutment section and the closure element. The release element is configured to hold the closure element in the outlet opening of the pipe section in a normal state such that the closure element closes the outlet opening of the pipe section in a sealed manner, i.e., sealed against the flow of sprinkler fluid, and to release the closure element from its position closing the outlet opening of the pipe section in a release state and thus to allow the flow of sprinkler fluid.

According to the invention, the closure element is a closure body made of an elastic, in particular spring-elastic, material, which is formed in one piece. This elasticity of the closure element means that the closure element can ensure a sufficient spring effect, in particular with regard to forces acting on the release element, so that a spring as an additional component—as is standard in the prior art—can be completely dispensed with and yet the release element in particular can be inserted into the sprinkler head and/or held in the sprinkler head—without damaging it through excessive force.

In particular, the closure element may consist not only of a single material, but also of a combination of materials while maintaining the one-piece design of the closure element. In particular, the closure element may have different areas with regard to their elasticity. It may be particularly advantageous to provide an inelastic or only slightly elastic region centrally in the closure element, while edges and/or outer regions of the closure element have a higher elasticity. Such a structure may in particular ensure that the closure element retains its original shape and/or is not deformed by the action of force in such a way that, for example, the release element can no longer be held and/or the sealing function can no longer be guaranteed and, at the same time, the edges and/or outer regions are so flexible that a sufficient sealing and/or spring effect can be achieved.

In particular, the one-piece closure body may be a separate component that is not firmly connected to any other component, in particular not to the release element. In particular, the closure body is not part of a coating of the release element and/or is not a cap firmly connected to the release element, in particular not one designed as a coating.

Advantageously, the closure body may be designed to withstand, in the normal state of the release element, a fluid pressure exerted on the closure body by the sprinkler fluid in the pipe section while maintaining the sealed closure of the outlet opening and, in the released state, to be moved out of the outlet opening by the fluid pressure in such a way that the outlet opening is released for the sprinkler fluid to flow. In particular, the closure body advantageously withstands a fluid pressure of at least 35 bar or 500 psi in the normal state.

In a further advantageous development, the sprinkler head according to the invention may have a nominal K-factor (sprinkler discharge factor) of at least 20 [L/min/(bar)^{1/2}], in particular at least 57 [L/min/(bar)^{1/2}], in particular at least 80 [L/min/(bar)^{1/2}], in particular at least 115 [L/min/(bar)^{1/2}], in particular at least 160 [L/min/(bar)^{1/2}], in particular at least 360 [L/min/(bar)^{1/2}], and/or up to 400 [L/min/(bar)^{1/2}] so that a sufficiently high flow of sprinkler fluid through the sprinkler head can be ensured. In particular, the sprinkler head or its design may be adapted with regard to the dimensioning of individual components, in particular the pipe section and the outlet opening, in such a way that a required K-factor can be guaranteed.

A glass ampule may be used advantageously as a release element. In particular, the glass ampule is filled with a gas and/or a fluid. In particular, it is advantageous to use a fluid with a boiling point that does not exceed a release temperature. Furthermore, the glass ampule can advantageously be designed in particular to be able to burst by heating. The bursting can be caused in particular by expansion of the gas and/or the fluid and/or by evaporation of the fluid in the glass ampule. Such a glass ampule as a release element may be released and burst in particular if, due to a fire, the ambient air around the sprinkler head or around the release element is heated to such an extent that the temperature rises above a release temperature of the thermal release element.

Advantageously, the closure body can seal the outlet opening in the normal state of the release element without interaction with another element existing in addition to the release element. In particular, potential vulnerabilities due to using additional components may then be avoided.

Advantageously, the closure body and/or release element, in particular the glass ampule, may be held in the normal state by a pre-tensioning force of between 200 N and 1000 N, in particular between 200 N and 800 N. In particular, this may ensure that the aforementioned components are not damaged by excessive force and/or are not deformed unintentionally or excessively. For example, excessive deformation of the closure body could lead to a loss of sealing. On the other hand, this prevents the much greater risk of unintentional damage to the release element, especially the glass ampule, due to excessive clamping force. In particular, this can result in either a loss of the release effect per se, for example, by leakage of the filled gas or the filled fluid from the glass ampule, or an unintentional bursting of the release element, in particular the glass ampule. The latter then inevitably leads to an unwanted transition from the normal state to the release state and ultimately to an unwanted flow of sprinkler fluid through the defective sprinkler head. In both cases, there is a risk of complete loss of functionality of the sprinkler head.

With particular advantage, the closure body may consist of a plastic, in particular a polymer, preferably a polyamide, in particular a partially aromatic polyamide. The plastic may in particular be fiber-reinforced, in particular with up to 70% fibers, especially glass fibers. With a closure body made of such a material, in particular the above-mentioned advantageous properties of the closure body may be achieved, or such a closure body may ensure a corresponding interaction with other components of the sprinkler head to achieve the described advantageous developments. A closure body made of a plastic may be manufactured cost-effectively in large quantities, particularly by means of an injection molding process.

The sprinkler head according to the invention may advantageously have a baffle and distribution plate for distributing the sprinkler fluid, as is basically known in sprinkler heads from the prior art. Such a baffle and distribution plate is used in particular to distribute the sprinkler fluid, which initially flows in from the front, over a correspondingly large area in order to be able to wet a large area with the sprinkler fluid, to provide preventive protection against fire or to fight a fire that has occurred there with the sprinkler fluid.

The objective is also achieved according to the invention by a closure body for a sprinkler head, in particular for a sprinkler head according to the invention, consisting of an elastic, in particular spring-elastic, material and formed in one piece. The advantages and advantageous developments of a closure body according to the invention described below also find applications to the closure body of a sprinkler head according to the invention, or the advantages and advantageous developments of a sprinkler head according to the invention can be transferred to a closure body according to the invention.

With particular advantage, the closure body may be formed in a plate shape. The plate shape may in particular have an outer, substantially flat edge section and a central protrusion for receiving a section of a release element. The edge section may advantageously be inclined to a main extension plane of the closure body, which may result in an improved sealing effect when the release element is inserted. The central protrusion may in particular serve to center the release element or simplify and/or effect reaching such a centering. In particular, the central protrusion may advantageously be shaped corresponding to a head of the release element, receive it and advantageously enclose it in order to provide the release element with additional stability, in particular with regard to movements of the release element parallel to the flat extension of the closure body.

In a particularly advantageous embodiment of a closure body according to the invention, the latter may consist of a plastic, in particular a polymer, preferably a polyamide, in particular a partially aromatic polyamide. It may then be manufactured in particular by injection molding.

In particular, the closure body may advantageously have a tensile modulus according to ISO 527-1/-2 between 20,000 and 40,000 MPa, in particular between 25,000 and 40,000 MPa, in particular between 25,000 and 30,000 MPa and/or a breaking stress according to ISO 527-1/-2 between 200 and 400 MPa, in particular between 250 and 400 MPa, in particular between 250 and 300 MPa and/or a breaking expansion according to ISO 527-1/-2 between 0.5 and 2.5%, in particular between 1 and 2% and/or Charpy impact strength according to ISO 179/1eU between 20 and 100KJ/m², especially between 40 and 80KJ/m², especially between 50 and 70 KJ/m² and/or Charpy notched impact strength according to ISO 179/1eA between 5 and 30KJ/m², especially between 10 and 20 KJ/m² have. A closure body with such a parameter(s) or with such parameter(s) may be achieved in particular by means of a design in the form of a closure body consisting of a, in particular fiber-reinforced, plastic, in particular a polymer, in particular advantageously by using a, in particular partially aromatic, in particular fiber-reinforced, polyamide as material for the closure body.

The objective is also achieved by the use of a closure body according to the invention in a sprinkler head, in particular in a sprinkler head according to the invention. Already described advantages and advantageous developments of a closure body according to the invention, or of a sprinkler head according to the invention, can be fully transferred to a use according to the invention.

The objective is also achieved by a sprinkler system with a sprinkler head according to the invention, in particular with a closure body according to the invention. Once again, the described advantages and advantageous developments of a sprinkler head according to the invention, or of a closure body according to the invention, can be fully transferred to a sprinkler system according to the invention.

### BRIEF DESCRIPTION OF THE DRAWINGS

Further advantages and features of the invention will be seen from the following description of possible embodiments with reference to the accompanying figures:

FIG. 1 (FIG. 1) shows an exploded view of a sprinkler head according to the invention with the closure body and release element shown in exploded view; and

FIG. 2 (FIG. 2) shows a sectional view of the sprinkler head according to

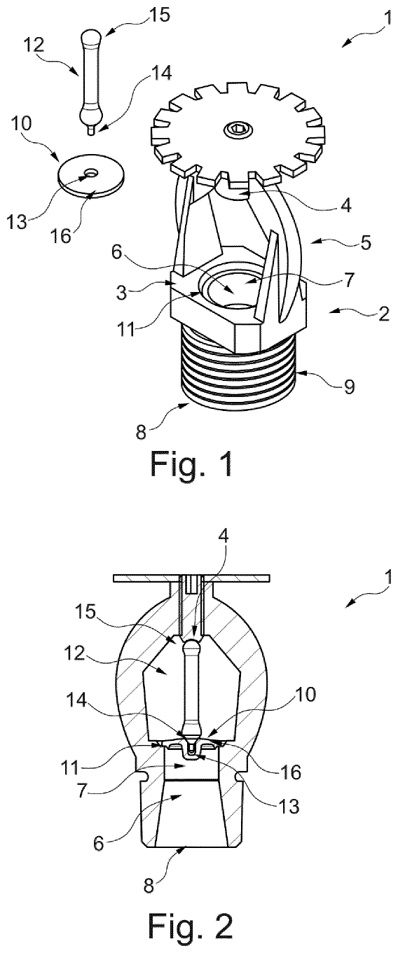

FIG. 1 with clamped closure body and release element.

### DETAILED DESCRIPTION

FIG. 1 shows a sprinkler head 1. The sprinkler head 1 has a sprinkler body 2 which consists of a base body 3, an abutment element 4 and a connection 5 between the base body 3 and the abutment element 4. The base body 3 has a pipe section 6 with an outlet opening 7 at the end represented at the top in the figure. In addition, there is an inlet opening 8 at the lower end of the pipe section 6 for introducing sprinkler fluid into the pipe section 6. Through the pipe section 6 with the inlet opening 8 and the outlet opening 7, a fluid channel 6, 7, 8 is thus formed for flow of sprinkler fluid through the sprinkler head 1. In addition, a thread 9 is provided on the outside of the base body 3, which enables the sprinkler head 1 to be inserted and fixed by screwing it onto a supply line for sprinkler fluid.

Furthermore, FIG. 1 shows a closure body 10. The closure body 10 is formed in one piece and has a substantially flat geometry. It serves for the sealed closure of the outlet opening 7 of the pipe section 6. For this purpose, a support 11 is provided in the area of the outlet opening 7, onto which the closure body 10 can be placed. In this respect, support 11 also forms a valve seat. It also helps to bring the closure body 10 correctly into the position required to seal the outlet opening 7 of the pipe section 6. In order for the closure body 10 to hold a fixed sealing in the outlet opening 7 of the pipe section 6 after the pipe section 6 has been subjected to sprinkler fluid or despite the resulting water pressure, it is necessary to clamp the closure body 10. This can be done by means of the release element 12, or the release element 12 and the closure body 10 are clamped together between the support 10 or respectively the base body 3 and the abutment element 4 (see FIG. 2). In the present case, the release element 12 is a glass ampule filled with a gas and/or a fluid which is designed to burst when a release temperature is reached due to the increased internal pressure caused by the heated gas and/or the heated fluid inside the glass ampule and thus to release the tension of the closure body 10 in the outlet opening 7 of the pipe section 6. As a result, the closure element 10 can no longer withstand the water pressure of the sprinkler fluid, so that it is driven out of the outlet opening 7 of the pipe section 6 by the sprinkler fluid. As a result, a fluid channel 6, 7, 8 is created that is continuous for the sprinkler fluid. To simplify correct clamping of the closure body 10 and the release element 12, the closure body 10 is plate-shaped and has a central protrusion 13 for receiving a tip 14 of the release element 12. Furthermore, this arrangement of the tip 14 in the central protrusion 13 can stabilize the release element 12 with respect to lateral movement from a clamped position.

FIG. 2 shows the sprinkler head 1 according to FIG. 1 with the closure body 10 and release element 12 clamped together. The closure body 10 rests on the support 11. The tip 14 of the release element 12 engages in the central protrusion 13 of the closure body 10. The release element 12 rests against the abutment element 4 with an ampule end 15. In order to achieve secure clamping, and in particular to make clamping possible at all, the closure body 10 consists of an elastic, in particular spring-elastic, material, preferably of a plastic, in particular of a polyamide, in particular a partially aromatic polyamide. In this respect, the closure body 10 formed in one piece according to the invention takes over in one element the parts of the closure body and the spring element which together form a closure arrangement (or closure element) in sprinkler heads known from the prior art by means of two elements. The closure body 10 receives a portion of the release element 12, seals the outlet opening 7 and provides the spring action caused by the separate spring in the sprinkler heads according to the state of the art.

In FIG. 2, the plate shape of the closure body 10 with an outer, substantially flat, however in particular substantially inclined at a shallow angle to the main extension plane of the closure body 13 extending edge section 16 as well as the central protrusion 13 can be clearly seen again. The central protrusion 13 engages in the clamped state into the outlet opening 7 of the pipe section 6. The closure element 10 rests on the support 11 with a part of the edge section 16. It can be seen that the one-piece closure element 10 seals the outlet opening 7 of the pipe section 6 in the clamped state to the release element 12 without interacting with another element existing next to the release element 12.

### LIST OF REFERENCE SIGNS

1 sprinkler head
2 sprinkler bodies
3 basic bodies
4 abutment element
5 connection
6 pipe section
7 outlet opening
8 inlet opening
9 threads
10 closure body
11 support
12 release element
13 central protrusion
14 tip
15 ampule end
16 edge section

1. A sprinkler head for a sprinkler system, comprising:
a pipe section for a sprinkler fluid, wherein the pipe section is designed at a first end for connecting to a connection of a sprinkler pipe of the sprinkler system and wherein the pipe section has an outlet opening at a second end;
a closure element designed for a sealed closure of the outlet opening of the pipe section;
an abutment element connected to the pipe section;
a release element arranged between the abutment element and the closure element, wherein the release element is formed:
in a normal state, to hold the closure element in the outlet opening of the pipe section in such a way that the closure element seals the outlet opening of the pipe section, and
in a release state, to release the closure element from its position closing the outlet opening of the pipe section,
wherein the closure element is a closure body consisting of an elastic material and the closure body is formed in one piece.

2. The sprinkler head according to claim 1, wherein the closure body is designed, in the normal state of the release element, to withstand a fluid pressure exerted on the closure body by the sprinkler fluid in the pipe section while maintaining the sealed closure of the outlet opening and, in the release state, to be moved out of the outlet opening by the fluid pressure in such a way that the outlet opening is released for the sprinkler fluid to flow.

3. The sprinkler head according to claim 2, wherein the closure body in the normal state withstands a fluid pressure of at least 30 bar.

4. The sprinkler head according to claim 1, wherein the sprinkler head has a nominal K-factor of at least 20 [L/min/(bar)^{1/2}], or up to 400 [L/min/(bar)^{1/2}].

5. The sprinkler head according to claim 1, wherein the closure body or the release element are held in the normal state by a pre-stressing force of between 200 N and 1000 N.

6. The sprinkler head according to claim 1, wherein the closure body seals the outlet opening in the normal state of the release element without interaction with a further element existing next to the release element.

7. The sprinkler head according to claim 1, wherein the closure body consists of a plastic.

8. The sprinkler head according to claim 1, wherein the release element is a glass ampule, wherein the glass ampule is designed to be able to burst by heating.

9. A closure body for a sprinkler head consisting of an elastic material and formed in one piece.

10. The closure body according to claim 9, wherein the closure body is plate-shaped with an outer, substantially flat edge portion and has a central protrusion for receiving a portion of a release element.

11. The closure body according to claim 10, wherein the edge section is inclined to a main extension plane of the closure body.

12. The closure body according to claim 9, wherein the closure body consists of plastic.

13. The closure body according to claim 9, wherein the closure body has a tensile modulus between 20,000 and 40,000 MPa or a breaking stress between 200 and 400 MPa or a breaking expansion between 0.5 and 2.5% or Charpy impact strength between 20 and 100KJ/m² or Charpy notched impact strength between 5 and 30KJ/m².

14. (canceled)

15. A sprinkler system comprising at least one sprinkler head according to claim 1.

16. The sprinkler head according to claim 8, wherein the glass ampule is filled with a gas or a fluid with a boiling point not exceeding a release temperature and is designed to be able to burst by expansion of the gas or the fluid or by evaporation of the fluid in the glass ampule.

17. The closure body according to claim 9, wherein the closure body consists of fiber reinforced plastic.

18. The sprinkler system according to claim 15, wherein the at least one sprinkler head comprises a closure body according to claim 9.
